(19) United States
(12) Patent Application Publication
(10) Pub. No.: US 2022/0401869 A1
(43) Pub. Date: Dec. 22, 2022

(54) AIR DUCT OPENING COVER ASSEMBLY AND METHOD OF COVERING AN AIR DUCT OPENING

(71) Applicant: Joseph E. Allington, Fort Myers, FL (US)

(72) Inventor: Joseph E. Allington, Fort Myers, FL (US)

(21) Appl. No.: 17/844,099

(22) Filed: Jun. 20, 2022

Related U.S. Application Data
(60) Provisional application No. 63/212,526, filed on Jun. 18, 2021.

(51) Int. Cl. B01D 46/16; B01D 46/00

(52) U.S. Cl. CPC B01D 46/16; B01D 46/0002; B01D 2265/028; B01D 2279/50

(57) ABSTRACT

An air duct opening cover assembly mountable on an air duct opening includes a cover body and a retainer system for securing the cover body across an air duct opening, such as to position an air filter element across the air duct opening. The retainer system may include a releasable clip for attachment to an edge of an air duct opening or ceiling structure. The cover body may include a retention grid for supporting the air filter element. The retainer system may include one or more fasteners, which may be elongated and elastically stretchable and/or adjustable to tension the fastener against the cover body and air filter element.

### CROSS-REFERENCE TO RELATED APPLICATIONS

This application claims the benefit of U.S. Provisional Patent Application No. 63/212,526, filed on Jun. 18, 2021, which is incorporated herein by reference in its entirety.

### FIELD OF THE INVENTION

The present invention relates generally to air conditioning filters, and more particularly, to an apparatus and method of preventing air contamination of a room by supporting an air filter element across an air duct opening in a ceiling.

### BACKGROUND OF THE INVENTION

Air conditioning systems are very useful and indeed in some climates even necessary to circulate fresh air throughout a building or room. The air conditioning systems typically include a network of air ducts extending from a source of fresh air to air duct outlets positioned throughout the building. Fresh air is forced into the rooms through the air duct outlets.

However, the circulation of air from room to room can become problematic in some instances. For example, dust, dirt, or other contaminants from an unoccupied room may be circulated into an occupied room creating a cleanliness and/or health hazard for the occupants. Further, should construction be occurring in one or more of the rooms, dust, dirt, and other contaminants from the construction material may get circulated into an occupied area of the house with the same results.

Accordingly, there is need for a solution to at least one of the aforementioned problems. For instance, there is an established need for solutions improving air filtering in existing air conditioning systems. There is a further established need that these solutions are easily installable and removable, to facilitate cleaning and/or replacement of components of the air conditioning system.

### SUMMARY OF THE INVENTION

The present invention is directed to an air duct opening cover assembly mountable on an air duct opening structure. The air duct opening cover assembly includes a retainer system for securing the air duct opening cover assembly across an air duct opening, and a cover body securable in place over the air duct opening by the retainer system, such as for positioning an air filter element across the air duct opening. The retainer system is easily and rapidly deployable to connect the cover body to the air duct opening, and to disconnect the cover body from the air duct opening structure.

In a first implementation, an air duct opening cover assembly mountable on an air duct opening formed in a structure may include a generally rigid cover body, positionable relative to an air duct opening formed in a structure such that the cover body extends over and across the air duct opening. The cover assembly may further include a retainer system connectable to the cover body and extendable over and outward of the cover body to a periphery of the cover body. The retainer system may include at least one fastener configured to connect to the structure at the periphery of the cover body. The air duct opening cover assembly may be configured to adopt an assembled configuration in which the cover body is positioned over and across the air duct opening, and the retainer system is connected to the cover body and extended over and outward of the cover body to the periphery of the cover body. In the assembled configuration, the at least one fastener may be connected to the structure, and the retainer system may maintain the cover assembly in place relative to the air duct opening.

In a second aspect, the cover body may include at least one opening for the passing of air therethrough.

In another aspect, the cover body may include a grid. The at least one opening may include a plurality of openings defined by the grid.

In another aspect, the cover body may include a peripheral frame and a plurality of internal cross-members extending from the peripheral frame. The peripheral frame and plurality of internal cross-members may form the grid and define the plurality of openings.

In another aspect, each fastener may include an attachment member, which may be elongately formed. The attachment member may have a first end portion connectable to a point of an internal cross-member, the point arranged in spaced-apart relationship with an outer edge of the cover body adjacent to the periphery of the cover body. The attachment member may be extendable from this point and over the internal cross-member to the outer edge of the cover body. A second end portion of the attachment member opposite to the first end portion may be extendable outward of the cover body to the periphery of the cover body and may carry a connector configured to connect with the structure.

In yet another aspect, the peripheral frame may include a plurality of edge members interconnected to one another and to the plurality of internal cross-members. The plurality of edge members may form a frame around the internal cross-members.

In another aspect, each fastener may include an attachment member, which may be elongately formed. The attachment member may have a first end portion connectable to a point of an edge member of the plurality of edge members. This point may be arranged in spaced-apart relationship with an outer edge of the cover body adjacent to the periphery of the cover body. The attachment member may be extendable from this point and over and along the edge member of the plurality of edge members to the outer edge of the cover body at an adjacent edge member of the plurality of edge members. A second end portion of the attachment member opposite to the first end portion may be extendable outward of the cover body to the periphery of the cover body and may carry a connector configured to connect with the structure.

In another aspect, each fastener of the at least one fastener may include an attachment member, which may be elongately formed and securable to the cover body at a respective first point of the cover body arranged in spaced-apart relationship with an outer edge of the cover body. The attachment member may be extendable over the cover body from the first point to the outer edge of the cover body. A portion of the attachment member may be extendable outward of the cover body to the periphery of the cover body and may carry a connector configured to connect with the structure.

In another aspect, the at least one fastener may include two fasteners, the two fasteners mountable to the cover body such that, in the assembled configuration, the respective attachment members of the two fasteners are overlapped with one another and extend in different directions.

In yet another aspect, the attachment member may be elastically stretchable.

In another aspect, a first end portion of the attachment member may include at least one protruding tab configured to engage with a tab-receiving opening formed in the cover body at the respective first point.

In another aspect, the at least one protruding tab may include two or more protruding tabs selectively connectable to the tab-receiving opening.

In another aspect, the attachment member may include a flat side configured to flatly rest on an outer surface of the cover body in the assembled configuration.

In yet another aspect, the connector may be disconnectably attachable to the portion of the attachment member.

In another aspect, the connector may be selectively securable to the portion of the attachment member at different longitudinal positions along the attachment member to adjust a distance between the connector and the first point.

In another aspect, the portion of the attachment member may include two or more tabs configured to selectively fasten to a tab-receiving opening formed in the connector.

In another aspect, the connector may include an elastic, retainer clip.

In yet another aspect, the retainer clip may include an angled arm, a lower clip member extending from the angled arm, a connecting member extending from the lower clip member and an upper clip member extending from the connecting member. The lower and upper clip members may define a gap therebetween configured to receive the structure.

These and other objects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIG. 1 presents a bottom isometric view of an air duct opening cover assembly including an air filter element, a retention grid, and a plurality of connection members for securing the air filter element and retention grid over an air duct opening in accordance with a first illustrative embodiment of the present invention;

FIG. 2 presents a top isometric view of the air duct opening cover assembly and air filter element of FIG. 1;

FIG. 3 presents an enlarged, bottom isometric view of a connector clip of a fastener of the retainer system of the cover assembly of FIG. 1, shown connected to an external structure;

FIG. 4 presents a bottom isometric view of the air duct opening cover assembly of FIG. 1 being positioned over an air duct opening provided in a suspended ceiling;

FIG. 5 presents an enlarged, bottom isometric view of the air duct opening cover assembly mounted to the suspended ceiling of FIG. 4, showing the cover assembly secured to the suspended ceiling by the connector clips;

FIG. 6 presents a bottom isometric view of a second embodiment of an air duct opening cover assembly in accordance with a further embodiment of the present invention;

FIG. 7 presents a top isometric view of the air duct opening cover assembly of FIG. 6;

FIG. 8 presents an enlarged, bottom isometric view of a connection member of the air duct opening cover assembly of FIG. 6, including a retainer having a rotatable tab for use in a dry wall environment;

FIG. 9 presents a bottom isometric view of the air duct opening cover assembly of FIG. 6 initially positioned over an air duct opening formed in a dry-walled ceiling;

FIG. 10 presents an enlarged, bottom isometric view of the air duct opening cover assembly secured to the dry-walled ceiling of FIG. 9 by the disclosed retainers;

FIG. 11 presents a bottom isometric view of an air duct opening cover assembly in accordance with a further embodiment of the invention, the cover assembly shown secured to a suspended ceiling by a plurality of adjustable, elongated fasteners;

FIG. 12 presents an enlarged, partial top isometric view of the cover body and fasteners of the cover assembly of FIG. 11;

FIG. 13 presents an enlarged, bottom isometric view of a connector of a fastener clipped onto an edge of a support frame of the suspended ceiling;

FIG. 14 presents an isometric view of a fastener of the cover assembly of FIG. 11, shown assembled; and

FIG. 15 presents an exploded isometric view of the fastener of FIG. 14.

Like reference numerals refer to like parts throughout the several views of the drawings.

### DETAILED DESCRIPTION

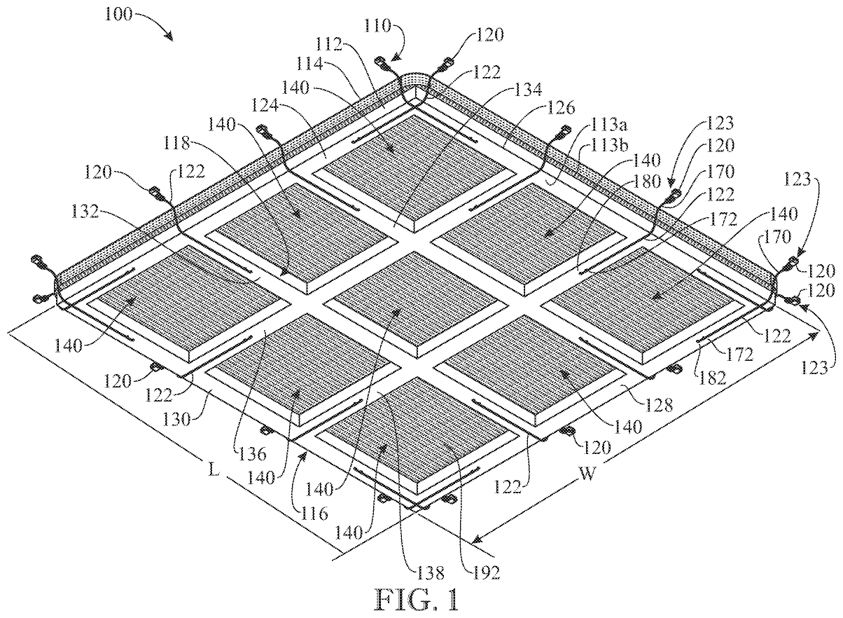

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

The present invention is directed toward an air duct opening cover assembly that can be positioned over an air outlet of an air duct system to filter the air exiting the air outlet. Shown throughout the figures are several illustrative embodiments of the invention.

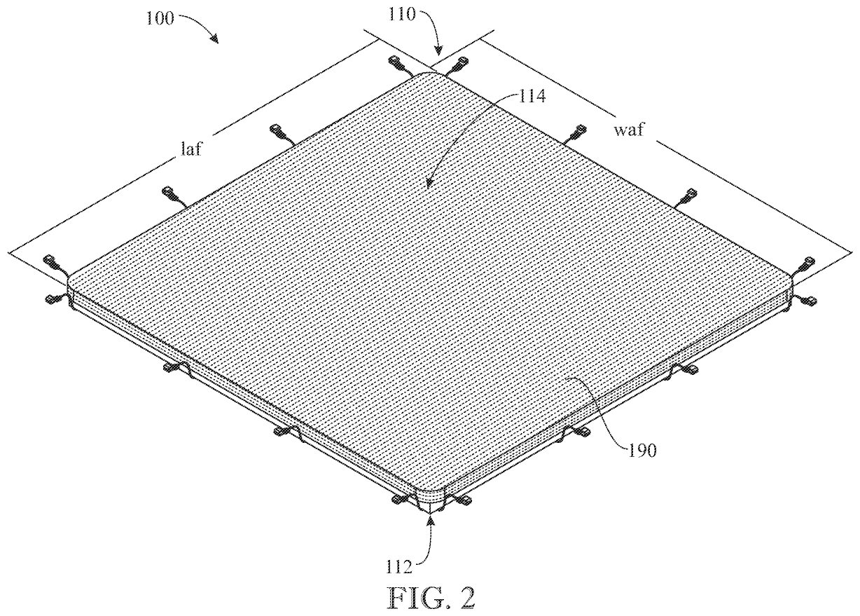

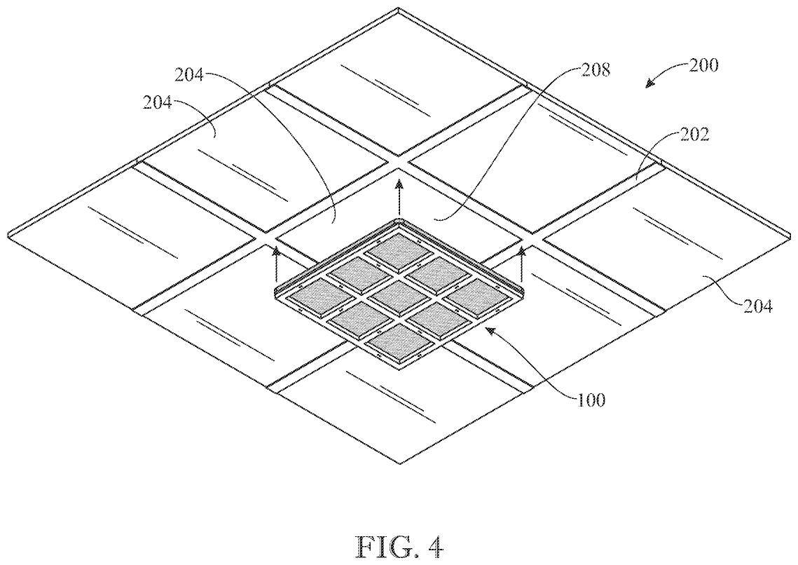

Referring to FIGS. 1-5, and initially with regard to FIGS. 1 and 2, an air duct opening cover assembly for use over an air outlet of an air duct system, hereinafter cover assembly 100, is illustrated in accordance with a first exemplary embodiment of the present invention. As shown, the cover assembly 100 generally includes a retainer system 110 and a cover body or retention grid 112 for retaining an air filter element 114 over an air outlet (e.g., air duct opening 208 of FIG. 4) of an air duct system. The air filter element 114 is suspended beneath and supported adjacent to and over the air outlet by the retention grid 112 and the retention grid 112 is affixed to the air duct opening or ceiling structure by the retainer system 110. As best shown in FIG. 1, the retention grid 112 is generally rigid and flat, and generally includes a peripheral frame 116 and an internal support grid 118 located within and extending from the peripheral frame 116. The peripheral frame 116 and the support grid 118 hold the air filter element 114 against the air duct opening as discussed in more detail hereinbelow.

In order to affix or removably attach the retention grid 112, and thus the air filter element 114, over an air duct opening, the retainer system 110 of the present embodiment generally includes at least one retainer clip 120 connected to the retention grid 112. The retainer clip 120 is provided to engage an edge or an air duct opening or other similar structure in a ceiling and adjacent to an air duct opening to hold the filter element 114 firmly against the air duct opening to filter air flowing there through. The retainer system 110 additionally includes at least one elongated, attachment member 122, in the form of a length of string or cable attached to and extending from the retention clip 120, with each retainer clip 120 and corresponding attachment member 122 forming an elongated fastener 123. The attachment member 122 is also attached to the retention grid 112. In this embodiment, the retainer system 110 includes a plurality of retainer clips 120 and attachment members 122 to secure the retention grid 112 and thus the air filter element 114 over an air duct opening as discussed below.

As best shown in FIG. 2, the air filter element 114 is a generally rectangular piece of porous material having pores sufficiently small enough to filter out contaminants such as, but not limited to, dust, dirt, and similar particulates. In specific applications, the filter element 114 may be chosen from a material that can also filter out biological contaminants. The filter element 114 can be formed from organic materials and/or synthetic materials. In a particular embodiment, the filter element 114 has a length “laf” and a width “waf” and is formed from an approximately 23-inch square section of foam material.

With reference again to FIG. 1, the retention grid 112 of the present embodiment includes the outer peripheral frame 116 and the internal support grid 118 extending from and surrounded by the outer peripheral frame 116. The outer peripheral frame 116 is rectangular and is also approximately 23-inches square to conform to the size of the filter element 116. The outer peripheral frame 116 has a length “L” and a width “W”. As shown, the outer peripheral frame 116 includes a first edge member 124, a second edge member 126, a third edge member 128 and a fourth edge member 130, extending from each other to form a quadrangular structure, as shown. The first and third edge members 124 and 128, respectively, are opposed and parallel to each other while the second and fourth edge members 126 and 130, respectively, are opposed and parallel to each other and generally perpendicular to the first and third edge members 124 and 128.

The internal support grid 118 of the retention grid 112 generally includes a plurality of cross members such as parallel first and second cross members 132 and 134 and parallel third and fourth cross members 136 and 138. As shown, the first and second cross members 132 extend from and between the first and third edge members 124 and 128 and 134 are generally parallel to the second and fourth edge members 126 and 130. In turn, the third and fourth cross members 136 and 138 extend from and between the second and fourth edge members 126 and 130 and are generally parallel to the first and third edge members 124 and 128 and perpendicular to the first and second cross members 132 and 134. The first and second cross members 132 and 134 and the third and fourth cross members 136 and 138, together with the peripheral frame 116, define a plurality of spaces or openings 140 through the retention grid 112 for the passage of filtered air as discussed below. In the present embodiment, the openings 140 are rectangular or square.

It should be noted that the first, second, third and fourth edge members 124, 126, 128 and 130, respectively, of the outer peripheral frame 116 may be formed integrally or may be formed separately and joined by various means such as, but not limited to, welding, gluing, joining with various types of fasteners, etc. Similarly, the first and second cross members 132 and 134 and the third and fourth cross members 136 and 138 of the internal support grid 118 may also be integrally formed together or may be formed separately and joined by the various known means. Further, the peripheral frame 116 and the internal support grid 118 may be joined together by known means or may be formed integrally with each other.

The retention grid 112 may be formed from a variety of organic and/or synthetic materials. For example, the retention grid 112 may be formed from a variety of attractive organic materials for aesthetic purposes. Such organic materials may include various woods such as, but not limited to, oak, maple or stained maple, cherry, walnut, bamboo, etc. Alternatively, the disclosed retention grid may be formed from a variety of synthetic materials such as, but not limited to, various plastics and/or polymers, metallic materials such as, but not limited to, stainless steel, aluminum, and the like. It should also be noted that the disclosed materials used in the formation of the retention grid 112 may be colored, stained, printed on with patterns, or otherwise treated for a more aesthetic appearances as well as to match the air duct opening and/or the surrounding ceiling.

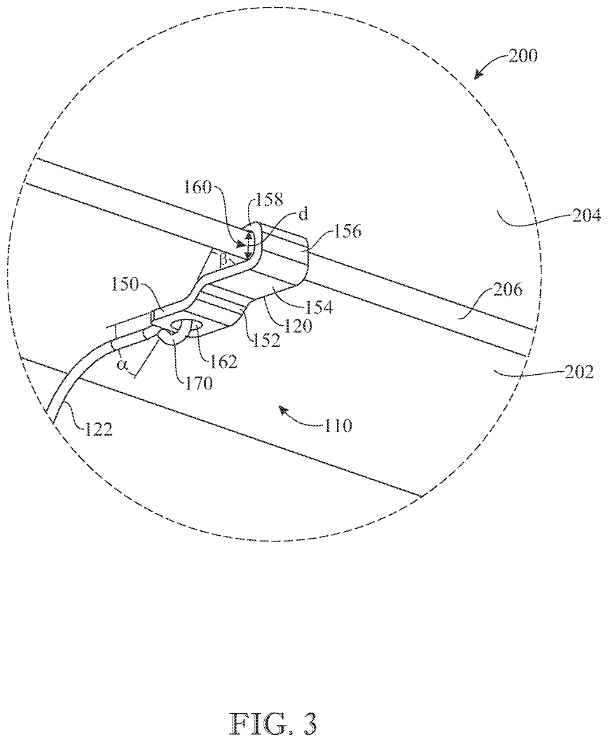

Turning now to FIGS. 3 and 4, the disclosed retainer system 110 is provided to removably retain the retention grid 112, and thus the air filter element 114, over an air duct opening to filter air flowing through the air duct opening. The retainer clip 120 of the retainer system 110 is used to attach the retention grid 112 to a suspended ceiling 200 (FIG. 4) having a support frame 202 and a plurality of ceiling panels 204 supported by the support frame 202. Specifically, in the illustrative application shown in the drawings, the retainer clip 120 is configured to attach to an edge 206 of the support frame 202 of the suspended ceiling 200. While not specifically shown, an air duct opening is positioned within or through one of the ceiling panels 204 or takes the place of one of the ceiling panels 204. Alternatively, while not specifically shown, the retainer clip 120 can similarly be attached to an edge of an air duct opening frame.

As best shown in FIG. 3, the retainer clip 120 generally includes a flat attachment plate 150 and a flat angled arm 152 extending from the attachment plate 150. A first or lower clip member 154 extends from the flat angled arm 152, and a connecting or upright member 156 extends from the lower clip member 154. A second or upper clip member 158 extends from the upright member 156 as shown. The angled arm 152 extends from the attachment plate at an angle α and the lower clip member 154 extends from the angled arm 152 at an angle β. In a preferred embodiment, the angle α and the angle β are 45° such that the lower clip member 154 is generally parallel to the attachment plate 150. The upright member 156 extends perpendicularly from the lower clip member 154, and the upper clip member 158 extends perpendicularly from the upright member 156. Thus, the lower and upper clip members 154 and 158, respectively, are parallel to each other and define a gap 160 therebetween for receipt of the edge 206 of the support frame 202 of the suspended ceiling 200. In a preferred embodiment, a width of the gap 160 or distance “d” between the lower and upper clip members 154 and 158 is approximately ⅛″. The length of the lower and upper clip members 154 and 158 is preferably ⅜″.

The retainer clip 120 may be formed from a variety of materials such as, but not limited to, metallic materials such as stainless steel or other steels, aluminum or aluminum alloys, brass, bronze, etc. Alternatively, the retainer clip 120 may be formed from plastic or polymeric materials. The materials chosen may be sufficiently flexible to allow the retainer clip 120 to fit over the edge 206 of the support frame 202 of the suspended ceiling 200, or edge of an air duct frame, in snap fit fashion. To enhance the clipping effect of the retainer clip 120 onto the edge 206 of the support frame 202, the retainer clip 120 may be elastically flexible such that, when the edge 206 is inserted into the gap 260, the retainer clip 120 presses against the edge 206.

As shown, an attachment hole 162 is defined through the attachment plate 150 of the retainer clip 120 for receipt of, and connection to, the attachment member 122. Specifically, a first end 170 of the attachment member 122 passes through the attachment hole 162 and is secured to the attachment plate 150 of the retainer clip 120.

The attachment member 122 may be completely flexible or slightly rigid. The attachment member 122 may be formed from elastic or inelastic materials. Such materials may include flexible string, elastic “bungee” type cords and/or cables, rigid cable or wire, etc. In embodiments in which the attachment member 122 is formed of an elastic material, the retainer system 112 can be rapidly and conveniently tensioned tight against an air duct opening and more easily adjust to different shapes, sizes or configurations of the edge 206 or other support structure to which the retainer system 112 is secured.

Where the attachment member 122 is very flexible, the attachment member 122 may be tied to the retainer clip 120 by passing the first end 170 of the attachment member 122 through the attachment hole 162 in the attachment plate 150 of the retainer clip 120 and tying or otherwise connecting the first end 170 of the attachment member to the attachment plate 150. Alternatively, the first end 170 can be tied back onto the remainder of the attachment member 122 to thereby secure the attachment member 122 to the retainer clip 120. Alternatively, where the attachment member 122 is more rigid, the first end 170 of the attachment member 122 is passed through the attachment hole 162 in the attachment plate 150 and bent, crimped, or otherwise secured to the attachment plate 150 of the retainer clip 120.

Turning back for the moment to FIG. 1, a second end 172 of the attachment member 122 opposite to the first end 170 is secured to the retention grid 112 of the cover assembly 100. As further shown, the second end 172 of the attachment member 122 may extend over and be secured to an outer side 113a of the retention grid 112 opposite to an inner side 113b of the retention grid 112 which faces the air filter element 114. In some embodiments, the second end 172 of the attachment member 122 may be secured to the retention grid 112 by gluing, welding, fusing, etc.

In the present embodiment, some of the attachment members 122 specifically attached to the internal support grid 118 of the retention grid 112. For example, the internal support grid 118 and, in particular, the first, second, third and fourth cross members 132, 134, 136 and 138, respectively, may be provided with holes 180 formed therethrough and the attachment member 122 secured thereto in similar manner as was heretofore described with reference to the attachment hole 162. Further, in some embodiments, such as the present embodiment, some of the attachment members 122 may be attached to the peripheral frame 116 of the retention grid 112. Specifically, holes 182 may be formed through the first, second, third and fourth edge members 124, 126, 128 and 130, respectively. The holes 182 may be spaced-apart from an outer edge of the cover body or retention grid 112, as shown. The second ends 172 of the attachment members 122 are secured within the holes 182 in the peripheral frame 116 in similar manner as was heretofore described with reference to the attachment hole 162.

Turning now to FIGS. 1-5, and initially with regard to FIG. 1, in use, the cover assembly 100 is assembled by positioning the air filter element 114 in the retention grid 112 such that an upper or top surface 190 of the air filter element 114 (FIG. 2) faces up and a lower or bottom surface 192 of the air filter element 114 rests on the internal support grid 118 of the retention grid 112 at the inner side 113b of the retention grid 112, with the peripheral frame 116 of the retention grid 112 arranged along an outer edge of the air filter element 114. In some embodiments, the bottom surface 192 of the air filter element 114 may also contact the peripheral frame 116 at the inner side 113b of the retention grid 112. The retainer system 110, including the retainer clips 120 and attachment members 122, is secured to the retention grid 112 in the manner described hereinabove.

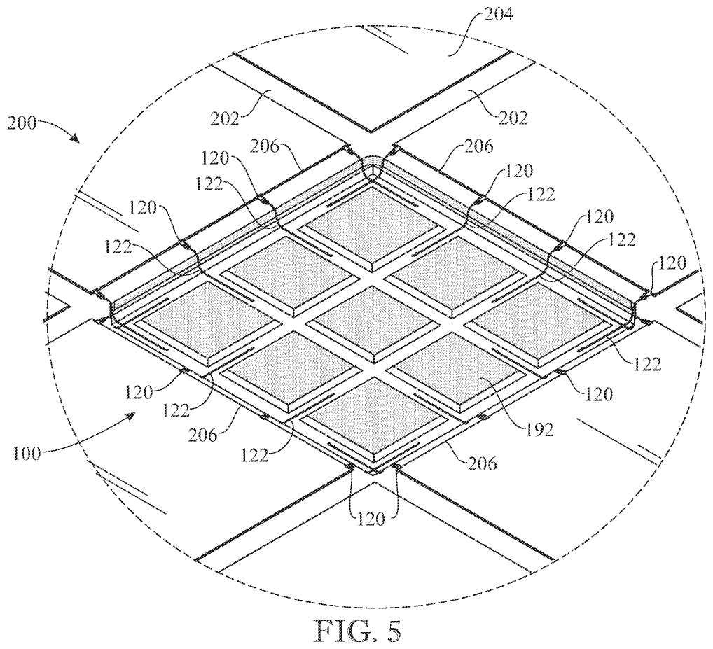

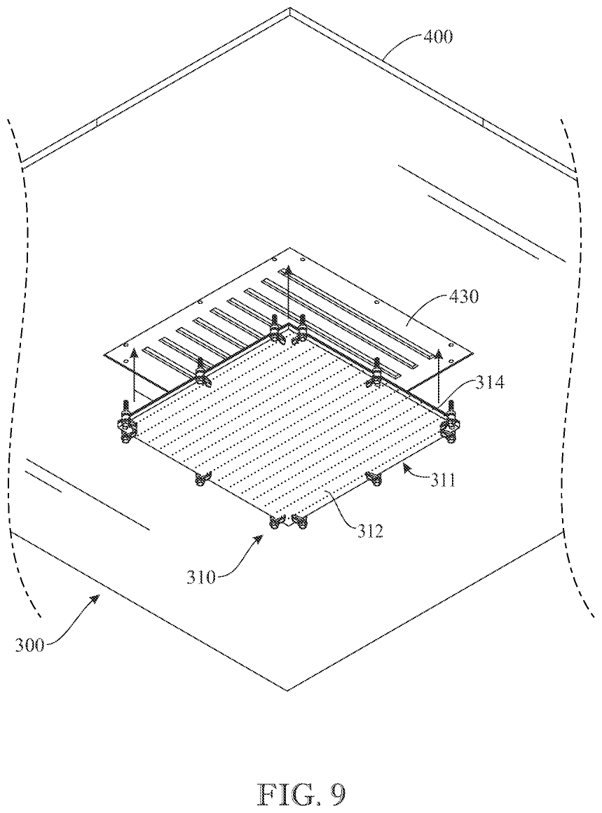

As best shown in FIG. 4, and as noted hereinabove, the suspended ceiling 200 includes the support frame 202 and the plurality of ceiling panels 204 supported by the support frame 202. An air duct opening 208 is formed through one of the ceiling panels 204. An air duct opening structure (similar to that shown in FIG. 9 hereinbelow) may be positioned in the air duct opening 208 of the ceiling panel 202 or may be supported by the support frame 202. In operation of the cover assembly 100, the cover assembly 100 is positioned in registration with the air duct opening 208, i.e. below the air duct opening 208, and moved towards the air duct opening 208 as shown in the figure. Once positioned adjacent to the air duct opening 208, the cover assembly 100 is secured to the support frame 202 of the suspended ceiling 200. Specifically, with regard to FIGS. 3 and 5, the retainer clips 120 of the retainer system 110 of the cover assembly 100 are positioned over the edges 206 of the support frame 202 of the suspended ceiling. The edges 206 of the support frame 202 are positioned within the gap 160 between the upper and lower clip members 158 and 158 and are retained therein in friction fit fashion. The attachment members 122, in turn, extend from their point of connection (hole 180, 182) to the cover body or retention grid 112, over the retention grid 112, and outwardly from the retention grid 112, as shown, and maintain the retention grid 112 in place against the air filter element 114. In this manner, the air filter element 114 is maintained in place against or adjacent to the air duct opening 208, such that the air filter element 114 is positioned at the air duct opening 208 by the retention grid 112. In this position, fluid communication is provided between the air duct opening 208 and the opening 140 of the retention grid 112 through the air filter element 114, allowing air pass through the assembly and become filtered in doing so. In embodiments in which the attachment member 122 is elastic, the elastic attachment member 112 pulls the first end 170 towards the second end 172 of the attachment member 112, thereby maintaining the retainer clip 120 engagement over the edges 206 of the support frame 202 and further maintaining the pushing of the retention grid 112 upward against the filter element 114 to maintain the filter element 114 in place relative to the air duct opening 208.

The disclosed cover assembly 100, through the use of the retainer clips 120 and attachment members 122, is maintained in position over the air duct opening 208 in the suspended ceiling 200. Air (not shown) flowing out of the air duct opening 208 engages the top surface 190 of the filter element 114, passes through the filter element 114 and out through the bottom surface 192 of the filter element 114. The filtered air then passes through the openings 140 in the retention grid 112 and into the room. Any contaminants or objectionable material and/or odors are thus filtered out of the air passing though the disclosed cover assembly 100. In other applications, air passing into the air duct opening 208 will first pass through the openings 140 in the retention grid 112 and then through the filter element 114, to filter out said harmful or undesirable agents.

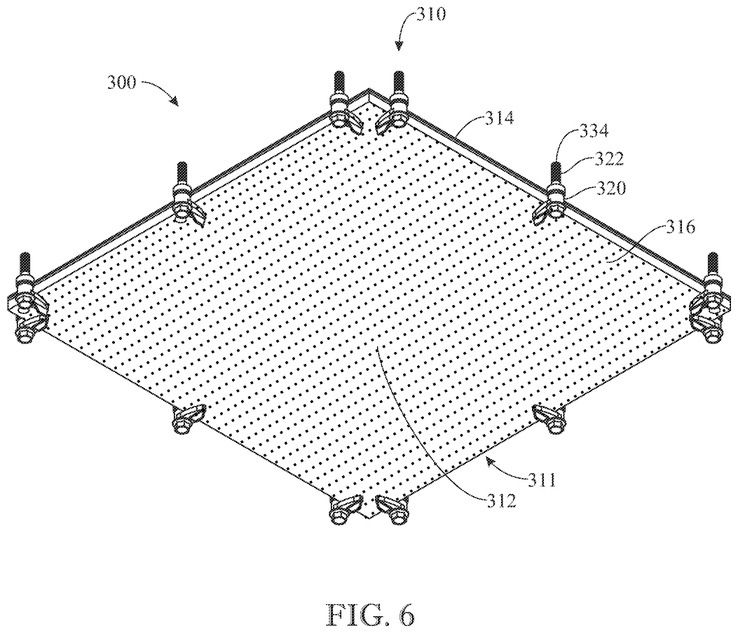

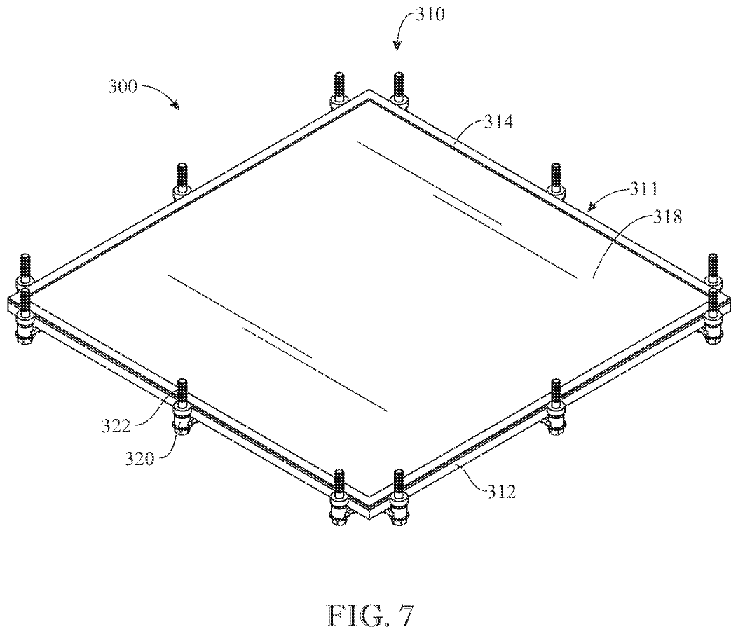

Turning now to FIGS. 6-10, and initially with regard to FIGS. 6 and 7, there is disclosed an alternative air duct opening cover assembly, hereinafter cover assembly 300, for use with solid ceiling surfaces such as, but not limited to, a dry wall ceiling 400 (FIG. 9). It should be noted that the cover assembly 300 may be used alone or in combination with the cover assembly 100 described hereinabove. Additionally, the cover assembly 300 may be secured over an air duct outlet or inlet with the disclosed retainer system 110 in the manner discussed hereinabove.

The cover assembly 300 generally includes an alternative retainer system 310 and a cover body 311, the cover body 311 comprising an air flow blocking plate 312 and gasket 314 and configured to extend over an air duct opening as described below. The gasket 314 is a generally rectangular, half-inch section of gasket material that lies along the perimeter of the air flow blocking plate 312 to prevent the flow of air into and out of an air duct around edges of the blocking plate 312. The air flow blocking plate 312 is a generally rectangular and solid piece of material for supporting blocking the flow of air through an air duct. In some preferred embodiments, the air flow blocking plate 312 may be generally rigid. The air flow blocking plate 312 lower or bottom surface 316 (FIG. 6) and an upper or top surface 318 (FIG. 7).

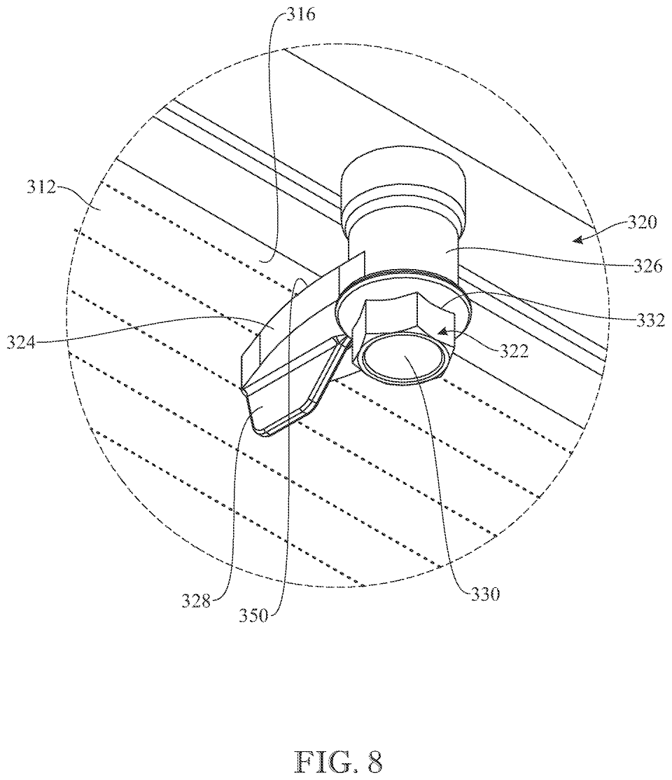

The retainer system 310 includes a plurality of fasteners 323 for securing the blocking plate 312 to the dry wall ceiling 400 (FIG. 9). Each fastener 323 includes a respective retainer clip 320 and a respective attachment shaft 322. With specific reference to FIG. 8, the retainer clip 320 generally includes a flat securing tab 324 and a hollow barrel shaped housing 326 affixed to the securing tab 324. While not specifically shown, the attachment shaft 322 extends through a bore in the housing 326 such that the retainer clip 320 is rotatably mounted on the attachment shaft 322. A finger tab 328 may be provided on the retainer clip 320 and extends from the securing tab 324. The finger tab 328 is provided to allow the securing tab 324 to be manually rotated about the attachment shaft 322 to removably secure the blocking plate 312 to the dry wall ceiling 400. The securing tab 324 is rotatable between a first position remote from the blocking plate 312 and a second position locating the securing tab 324 over the blocking plate 312 to support the blocking plate 312 and gasket 314 against the dry wall ceiling 400 to prevent the flow of air through an air duct.

The attachment shaft 322 of the retainer system 310 has a bolt head 330 formed on a first end 332 of the attachment shaft 322. A second end 334 of the attachment shaft 322 (FIG. 6) includes structure for securing the second end of the attachment shaft 322 into the dry wall ceiling 400. Such structure may include a threaded outer surface on the second end 334 of the attachment shaft 322. In a particular embodiment, an expandable molly type structure is provided on the second end of the attachment shaft 322 which can be driven into and expanded within the dry wall ceiling 400 to secure the retainer clip 320 to the dry wall ceiling 400.

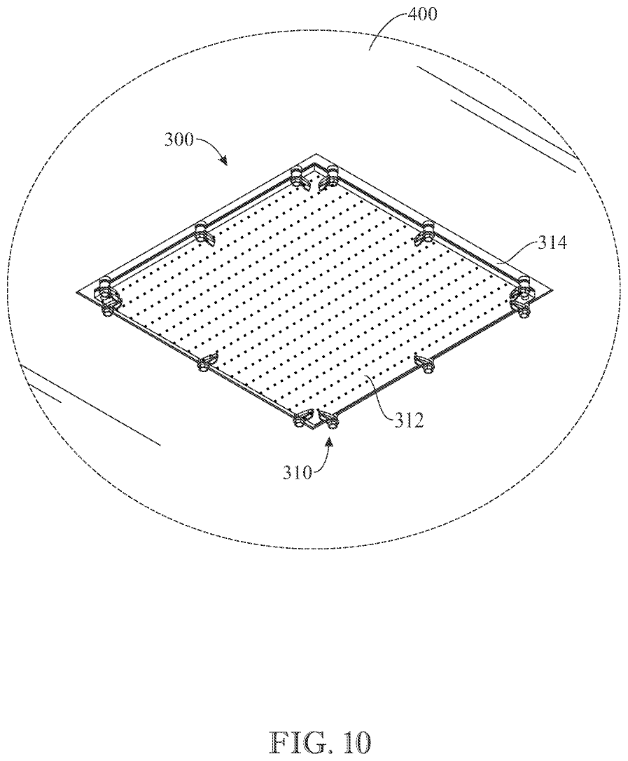

Referring now to FIGS. 6-10, the use of the disclosed cover assembly 300 to cover an air duct opening, such as, but not limited to, air duct outlet or vent 430 located in the dry wall ceiling 400 will now be described. The retainer system 310 is positioned about a peripheral edge 340 of the blocking plate 312 and the cover assembly 300 is positioned over the air duct vent 430 (FIG. 9). The gasket 314 is positioned between the blocking plate 312 and the ceiling 400. The second ends 334 of the attachment shafts 322 of the retainer system 310 are driven or otherwise anchored into the dry wall ceiling 400 in such a manner as to maintain the rotatability of the retainer clip 320 on the attachment shafts 322 (FIG. 10). A flat upper surface 350 of the flat securing tab 324 of the retainer clip 320 supports the flat bottom surface 316 of the blocking plate 312 (FIG. 8).

Thus, the air flow blocking plate 312 is positioned and supported across the air duct vent 430, and jointly with the sealing gasket 314 blocks the flow of air entering and/or exiting the air duct vent 430. The disclosed cover assembly 300 may be used over an air intake duct in the room, area, or space under construction or otherwise dirty or can be positioned over an air outflow duct in a room to be protected. Should the user desire to remove the gasket 314 for cleaning and/or replacement, the finger tabs 328 on the retainer clips 320 are pushed or otherwise engaged to rotate the flat securing tabs 324 out of engagement with the blocking plate 312. The blocking plate 312 can then be drawn away from the dry wall ceiling 400 and the gasket 314 removed for cleaning and/or replacement.

It should be noted that the disclosed retainer system 310, including the retainer clips 320 and attachment shafts 322 can be pre-positioned about the air duct vent 430 in the dry wall ceiling 400. In this method of positioning the disclosed cover assembly 300 over the air duct vent 430, the finger tabs 328 are used to swing or rotate the securing tabs 324 of the retainer clip about the attachment shafts 322 to allow the combination blocking plate 312 and gasket 314 to be initially positioned over the air duct vent 430. Once properly positioned over the air duct vent 430 in the dry wall ceiling 400, the blocking plate 312 and gasket 314 can be secured to the dry wall ceiling 400 by rotating the retainer clips 322 such that the flat securing tabs 324 engage and support the blocking plate 312 and gasket 314 against the dry wall ceiling 400 to prevent the flow of air through a duct located therein.

In this manner, the disclosed cover assembly 300 provides an easily attachable device for covering an air duct vent to block the air flowing in or out thereof. Additionally, the cover assembly 300 allows for easy access to and removal of the gasket 314 for cleaning and/or replacement.

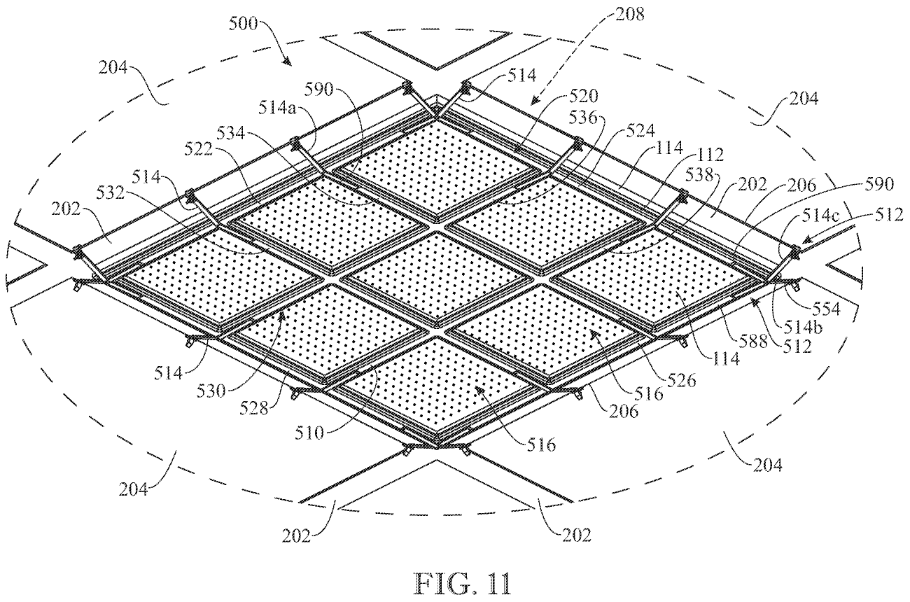

The illustrations of FIGS. 11-15 show an air duct opening cover assembly, hereinafter cover assembly 500, mountable on an air duct opening formed in a structure in accordance with yet another embodiment of the invention. Similarly to the previous embodiments, the cover assembly 500 includes a generally rigid, cover body 510, which may be positioned relative to an air duct opening formed in a suspended ceiling or other structure, such that the cover body extends over and across the air duct opening, with a filter element 114 arranged between the air duct opening and the cover body 510. For example, the illustration of FIG. 11 shows the cover body 510 positioned over and across an air duct opening 208 formed in a suspended ceiling 200 of the type described heretofore with reference to FIGS. 1-5. Air filter element 114, also heretofore described, may be mounted between the cover body 510 and the air duct opening 208 and may be retained in place with respect the air duct opening 208 by the cover assembly 500. Further similarly to previous embodiments, the cover assembly 500 of the present embodiment includes a retainer system 512 connectable to the cover body 510 and configured to secure the cover body 510 to the suspended ceiling 200. Similarly to the previous embodiments, the retainer system 512 includes at least one fastener 514, and more preferably, a plurality of fasteners 514, configured to connect to the structure (e.g., to the suspended ceiling 200). As best shown in FIG. 11, the retainer system 512 is extendable over and outward of the cover body 510 to a periphery of the cover body 510, and it is at the periphery of the cover body 510 where the retainer system 512 is secured to the suspended ceiling or other structure at which the air duct opening is located.

With continued reference to FIG. 11, the cover assembly 500 is shown in an assembled configuration in which the cover body 510 is positioned over and across the air duct opening 208, with the air filter element 114 retained between the cover body 510 and the air duct opening 208 and retained in place by the cover assembly 500. In this assembled configuration, the retainer system 512 is connected to the cover body 510 and is arranged extending over and outward of the cover body 510 to the periphery of the cover body 510. The fasteners 514 forming the retainer system 512 are connected to the suspended ceiling 200, and maintain the cover body 510 in place relative to the air duct opening 208, with the air filter element 114 arranged therebetween, and further with the air filter element 114 kept in place relative to and preferably elastically biased towards the air duct opening 208. Such connection of the fasteners 514 at the periphery of the cover body 510 facilitates installation, removal, and maintenance of the cover assembly 500, and further enables an effective tensioning of the cover assembly 500 and air filter element 114 support thereon, vertically upward against the air duct opening 208 by means of the readily fasteners, particularly in embodiments in which the fasteners are elastic or elastically stretchable as will be described hereinafter.

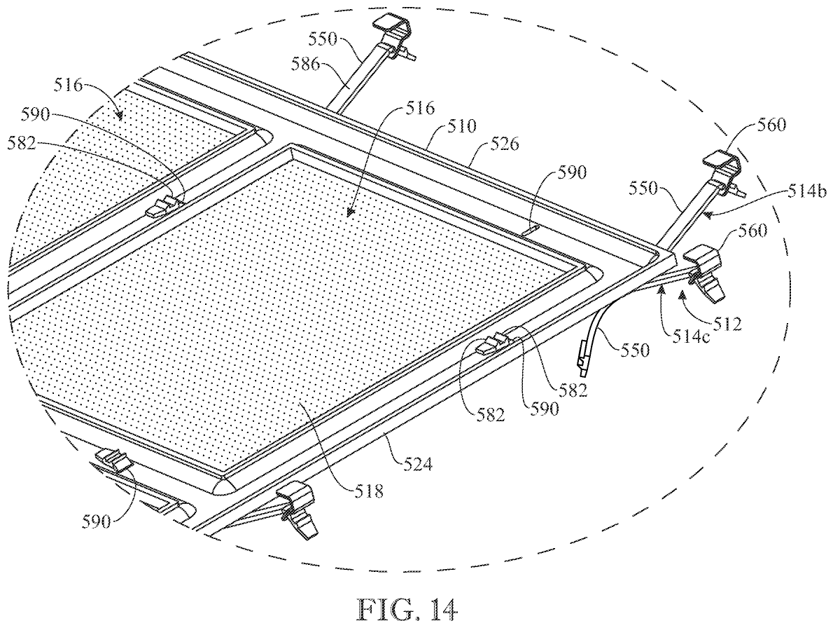

As shown, the depicted cover body 510 is formed as a grid and includes a plurality of openings 516 for the passing of air therethrough, similarly to the embodiment of FIGS. 1-5. However, alternative embodiments are contemplated in which the cover body 510 may present alternative configurations and/or a different number of openings, including a single opening or no openings (e.g., in embodiments or applications not including an air filter element). In some embodiments, as shown for instance in FIG. 11, the opening or openings 516 may be entirely open; in other embodiments, the opening or openings 516 may be instead provided with a material, sheet, screen, or the like, hereinafter referred to as material 518, an example of which is shown in FIG. 14; the material 518 may extend across the opening 516 such as to provide further filtering, insulation, or other applicable uses.

The grid type, cover body 510 specifically depicted in the figures includes a peripheral frame 520 and a plurality of internal cross-members 530 extending from the peripheral frame 520, similarly to the cover body or retention grid 112 of FIGS. 1-5. The peripheral frame 520 is formed by first, second, third and fourth edge members 522, 524, 526 and 528, respectively, which extend from one another forming a rectangular arrangement. The plurality of internal cross-members, in turn, includes first, second, third and fourth cross-members 532, 534, 536, and 538, respectively. The peripheral frame 520 and plurality of internal cross-members 530 form a grid and define the plurality of openings 516 therebetween. However, unlike the previous embodiment, where the retention grid 112 is of edge members and cross-members having a generally rectangular cross-section, the cover body 510 of the present embodiment is formed with a relatively recessed upper side, best shown in FIG. 12, which may be obtained, for instance and without limitation, by injection molding, stamping or other applicable manufacturing procedure and may provide a lighter resulting weight, more sleek design, and/or other advantageous effects. It should be noted, however, that alternative shapes and designs are applicable without departing from the scope of the present disclosure. In some embodiments, the cover body, including cover bodies 112, 311 and 510 described herein, may be integrally formed into a single-piece unit.

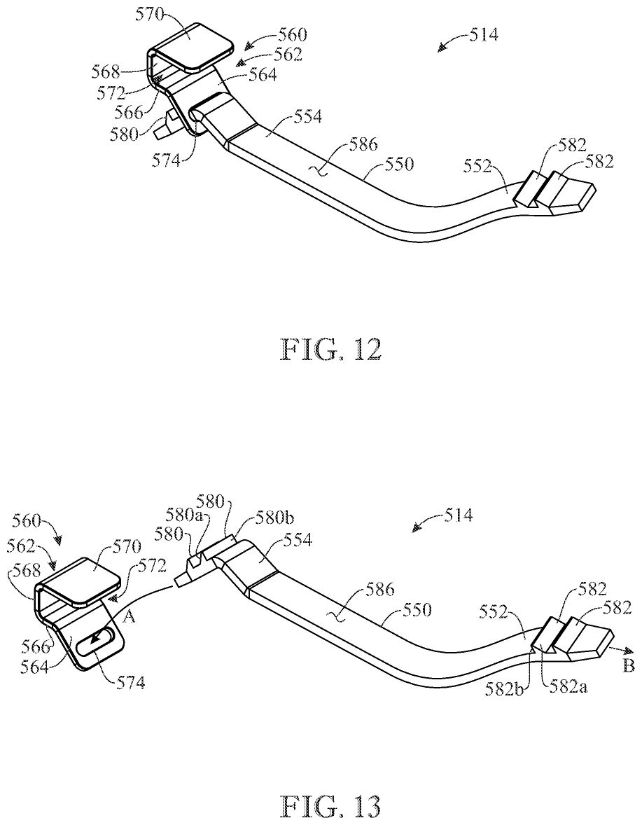

The illustrations of FIGS. 12 and 13 depict an assembled and an exploded view of a fastener 514 of the present embodiment, respectively. With reference initially to FIG. 12, as shown, the fastener 514 includes an elongated attachment member 550. The attachment member 550 may be deformable, such as twistable or bendable, and is more preferably elastically deformable. In preferred embodiments, such as the present embodiment, the attachment member 550 may be elastically stretchable. In non-limiting examples, the attachment member 550 may be made of silicone, plastic, or rubber. The attachment member 550 has a first end portion 552 and an opposite, second end portion 554. The first end portion 552 of the attachment member 550 is securable to the cover body 510. In turn, the second end portion 554 carries a connector 560 configured to connect to the external structure, such as, but not limited to, an edge 206 of a support frame 202 of the suspended ceiling 200.

With continued reference to FIG. 12, in some embodiments, the connector 560 may include an elastic, retainer clip 562. The retainer clip 562 may include an angled arm 564, a lower clip member 566 extending from the angled arm 564, a connecting member 568 extending from the lower clip member 566, and an upper clip member 570 extending from the connecting member 568. The lower and upper clip members 566 and 570 define a gap 572 therebetween configured to receive the edge 206 of the support frame 202 or other external structure. In some embodiments, such as the present embodiment, the lower clip member 566 may be oriented parallel to the upper clip member 570. The retainer clip 562 may be elastically formed such that the lower and upper clip members 566 and 570 are elastically biased towards one another to maintain a clipping effect on the edge 206 of the support frame 202 or other external structure.

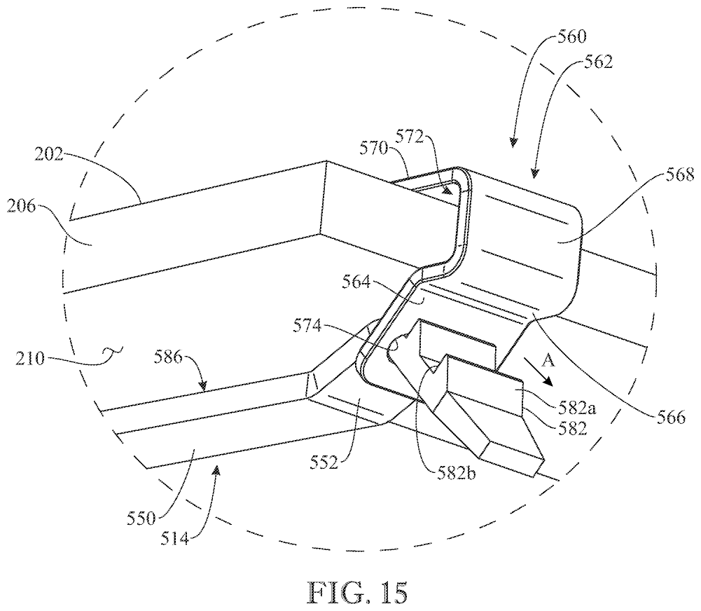

In some embodiments, the attachment member 550 may be disconnectably attachable to the connector 560. Furthermore, the connector 560 may be selectively securable to the second portion 554 of the attachment member 550 at different longitudinal positions along the attachment member 550 to adjust a distance between the connector 560 and the point on the cover body 510 at which the attachment member 550 connects to the cover body 510. For instance, the second portion 554 of the attachment member 550 may include two or more tabs 580 arranged in different, spaced-apart discrete positions along the second portion 554 of the attachment member 550; by way of example, the present embodiment has been illustrated to include two tabs 580. The tabs 580 are configured to selectively fasten to a tab-receiving opening 574 formed in the connector 560. For instance, the tabs 580 may be elastically deformable and may be compressed to fit through the tab-receiving opening 574, as indicated by arrow A in FIGS. 13 and 15, and then released and elastically biased to no longer fit through the tab-receiving opening 574 and thus retain the second portion 554 within the tab-receiving opening 574, as shown in FIG. 12. Furthermore, the tabs 580 may have a sloped or otherwise tapered profile on one side 580a thereof which facilitates passing the tab 580 through the tab-receiving opening 574 in one direction (insertion direction indicated by arrow A). An opposite side 580b of the tabs 580 may be less sloped or even generally perpendicular to the second portion 554 to at least partially block, and more preferably prevent, the tabs 580 from slipping through the tab-receiving opening 574 in a direction opposite to arrow A unless the tabs 580 are intentionally compressed by an operator, either manually or using a tool.

In some embodiments, as further shown, the first end portion 552 of the attachment member 550 may include at least one protruding tab 582, and more preferably, two or more tabs 582, configured to engage with a tab-receiving opening 590 formed in the cover body 510, defining the point at which the first end portion 552 connects to the cover body 510. The tab-receiving opening 590 may be arranged in spaced-apart relationship with an outer edge of the cover body 510. In some embodiments, the tab-receiving opening 590 may extend through the cover body 510, such that, as best shown in FIG. 14, the tabs 582 may be accessed on a top or upper side of the cover body 510, shown in the figure, allowing for an easy and rapid manipulation of the tabs 582 from the upper side of the cover body 510. The tabs 582 may have a sloped or otherwise tapered profile on one side 582a thereof which facilitates passing the tab 582 through the tab-receiving opening 590 in one direction (insertion direction indicated by arrow B). An opposite side 582b of the tabs 582 may be less sloped or even generally perpendicular to the first portion 552 to at least partially block, and more preferably prevent, the tabs 582 from slipping through the tab-receiving opening 590 in a direction opposite to arrow B unless the tabs 582 are intentionally compressed by an operator, either manually or using a tool.

With continued reference to FIGS. 12 and 13, the attachment member 550 may include a generally flat side 586 configured to flatly rest on an outer surface 588 of the cover body 510 and/or an outer surface 210 of the structure (e.g., an outer surface 210 of the support frame 202) in the assembled configuration, as shown in FIGS. 11 and 15. For instance, the attachment member 550 may be formed generally as a flat strip, as best shown in FIGS. 12, 13 and 15. By flatly resting on the outer surface 588 of the cover body 510 and/or the outer surface 210 of the external structure, the attachment member 550 may further contribute to stabilize the cover body 510 and air filter element 114 supported thereon in response to lateral forces.

The depicted embodiment, provided with a generally planar elastic attachment member 550 and tabs 580, 582 may be advantageously manufactured into an integral, single-piece unit. However, it should be noted that alternative embodiments are contemplated. For example, the attachment member may include more than one part. Alternatively or additionally, the number of tabs 580 and the number of tabs 582 may vary from one to any. In another example, a different attachment mechanism (e.g., hook, clip, fold, clamp, etc.) may be used to secure the first portion 552 to the cover body 510 and/or to secure the second portion 554 to the connector 560.

In operation of the cover assembly 500, an operator may secure the fasteners 514 to the cover body 510 by selectively connecting a tab 582 of each fastener 415 to a respective tab-receiving opening 590 of the cover body 510. With the fasteners 514 suspended from the cover body 510, the operator may then place an air filter element 114 on top of and in registration with the cover body 510, and may then position the air filter element 114 and cover body 510 over an air duct opening 208, such that fluid communication is provided between the air duct opening 208 and the openings 516 of the cover body 510 through the air filter element 114. The operator may next connect the fasteners 514 to surrounding structure by grasping the connector 560, pulling on the preferably elastically-stretchable attachment member 550 to extend the fastener 514 over to a selected structure (e.g., edge 206) and connect the connector 560 to the selected structure as described heretofore. Should the length of the fastener 514 not be satisfactory to achieve a proper tensioning or approximation of the cover assembly 510 and air filter element 114 relative to the air duct opening 208, the operator may adjust the fastener tension by manually repositioning the tabs 580 and/or 582 of one or more fasteners 514 at their respective tab-receiving opening 574 and/or 590 to vary the distance between the connector 560 and the opening 590 of the cover body 510.

As best shown in FIG. 11, the fasteners 514 may be arranged such that the attachment member 550 extends from a respective opening 590 of the cover body 510 to the outer edge of the cover body 510, and may be further deployed such that a remaining portion of the attachment member 550 extends outward of the cover body 510 to the periphery of the cover body 510 at which the connector 560 is to be connected to the structure (e.g., edge 206). In some embodiments, such as the present embodiment, the fasteners 514 may be arranged in different orientations, contributing to stabilize the cover assembly 500 and air filter element 114 relative to the air duct opening 208. For example, some fasteners (e.g., fastener 514a) may be connected to a point (opening 590) located at an internal cross-member (e.g., second cross-member 534) and arranged in spaced-apart relationship with an outer edge of the cover body 510 adjacent to the periphery of the cover body 510 to which the fastener 514 extends and at which the connector 560 is connected to the structure. The attachment member 550 of such fasteners (e.g., fastener 514a) may be extended from the point (opening 590) at the internal cross-member (e.g., second cross-member 534) and over the internal cross-member to the outer edge of the cover body 510. In other cases, as shown in the figure, the fasteners 514 (e.g., fastener 514b) may be arranged such the first end portion 552 is connected to a point (opening 590) of an edge member (e.g., second edge member 524) which is spaced apart from an outer edge of the cover body 510 from which the fastener is to be extended. The operator may connect the fastener (e.g., fastener 514b) and extend its attachment member 550 from the point of attachment to the cover body 510 (opening 590), and deploy the attachment member 550 over and along the edge member (e.g., second edge member 524) to the outer edge of the cover body 510 at an adjacent edge member (e.g., third edge member 526). The operator may then extend the second end portion 554 of the attachment member 550 outward of the cover body 510 to the periphery of the cover body 510 and proceed to fasten the connector 560 to the edge 206 or other structure. When deploying the fasteners 514, the flat side 586 of the attachment members 550 may be oriented upward and be positioned to flatly rest on adjacent surfaces, as described heretofore, for enhanced stability.

As further shown in FIG. 11, fasteners 514 may be mounted in overlapping relationship and in different orientations with respect to one another to further stabilize the fasteners 514 and cover body 510. For instance, fasteners 514b and 514c are mounted with their respective attachment members 550 overlapped with one another and extending in different directions, such as perpendicularly to each other.

The cover assembly disclosed herein may be easily removed from the air duct opening 208 in order to clean the duct, replace the air filter element 114, or carry out any other applicable task. An operator may disconnect all or some of the fasteners from the edge 206 or other external structure, and move the cover assembly away. During the filter replacement task or other applicable task, the cover assembly may optionally remain suspended from the edge 206 or structure by remaining fasteners which have not been disconnected, facilitating mounting the cover assembly back onto the ceiling or structure once the task has been completed. In the event that the air filter element 114 must be replaced, removal of the air filter element 114 from the cover assembly is facilitated by the fact that the air filter element 114 may be sandwiched between the air duct opening 208 without the need for any fasteners to be specifically and directly connected to the air filter element 114.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalents.

What is claimed is:

1. An air duct opening cover assembly mountable on an air duct opening formed in a structure, the air duct opening cover assembly comprising:
a generally rigid, cover body, the cover body positionable relative to an air duct opening formed in a structure such that the cover body extends over and across the air duct opening; and
a retainer system connectable to the cover body and extendable over and outward of the cover body to a periphery of the cover body, the retainer system comprising at least one fastener configured to connect to the structure at said periphery of the cover body; wherein
the air duct opening cover assembly is configured to adopt an assembled configuration in which the cover body is positioned over and across the air duct opening, and the retainer system is connected to the cover body and extended over and outward of the cover body to said periphery of the cover body, with the at least one fastener connected to the structure, the retainer system maintaining the cover assembly in place relative to the air duct opening.

2. The air duct opening cover assembly of claim 1, wherein the cover body comprises at least one opening for the passing of air therethrough.

3. The air duct opening cover assembly of claim 1, wherein the cover body comprises a grid, and the at least one opening comprises a plurality of openings defined by said grid.

4. The air duct opening cover assembly of claim 3, wherein the cover body comprises a peripheral frame and a plurality of internal cross-members extending from the peripheral frame, the peripheral frame and plurality of internal cross-members forming said grid and defining the plurality of openings.

5. The air duct opening cover assembly of claim 4, wherein each fastener of the at least one fastener comprises an attachment member, the attachment member elongately formed and having a first end portion connectable to a point of an internal cross-member, said point arranged in spaced-apart relationship with an outer edge of the cover body adjacent to said periphery of the cover body, wherein the attachment member is extendable from said point and over the internal cross-member to the outer edge of the cover body, and further wherein a second end portion of the attachment member opposite to the first end portion is extendable outward of the cover body to said periphery of the cover body and carries a connector configured to connect with the structure.

6. The air duct opening cover assembly of claim 4, wherein the peripheral frame comprises a plurality of edge members interconnected to one another and to the plurality of internal cross-members and forming a frame around the internal cross-members.

7. The air duct opening cover assembly of claim 6, wherein each fastener of the at least one fastener comprises an attachment member, the attachment member elongately formed and having a first end portion connectable to a point of an edge member of the plurality of edge members, said point arranged in spaced-apart relationship with an outer edge of the cover body adjacent to said periphery of the cover body, wherein the attachment member is extendable from said point and over and along said edge member of the plurality of edge members to the outer edge of the cover body at an adjacent edge member of the plurality of edge members, and further wherein a second end portion of the attachment member opposite to the first end portion is extendable outward of the cover body to said periphery of the cover body and carries a connector configured to connect with the structure.

8. The air duct opening cover assembly of claim 1, wherein each fastener of the at least one fastener comprises an attachment member, the attachment member elongately formed and securable to the cover body at a respective first point of the cover body arranged in spaced-apart relationship with an outer edge of the cover body, said attachment member extendable over the cover body from said first point to the outer edge of the cover body, wherein a portion of said attachment member is extendable outward of the cover body to said periphery of the cover body and carries a connector configured to connect with the structure.

9. The air duct opening cover assembly of claim 8, wherein said at least one fastener comprises two fasteners, the two fasteners mountable to the cover body such that, in the assembled configuration, the respective attachment members of the two fasteners are overlapped with one another and extend in different directions.

10. The air duct opening cover assembly of claim 8, wherein the attachment member is elastically stretchable.

11. The air duct opening cover assembly of claim 8, wherein a first end portion of the attachment member comprises at least one protruding tab configured to engage with a tab-receiving opening formed in the cover body at said respective first point.

12. The air duct opening cover assembly of claim 11, wherein said at least one protruding tab comprises two or more protruding tabs selectively connectable to said tab-receiving opening.

13. The air duct opening cover assembly of claim 8, wherein said attachment member comprises a flat side configured to flatly rest on an outer surface of the cover body in the assembled configuration.

14. The air duct opening cover assembly of claim 8, wherein the connector is disconnectably attachable to said portion of the attachment member.

15. The air duct opening cover assembly of claim 8, wherein the connector is selectively securable to said portion of the attachment member at different longitudinal positions along the attachment member to adjust a distance between the connector and the first point.

16. The air duct opening cover assembly of claim 15, wherein said portion of the attachment member comprises two or more tabs configured to selectively fasten to a tab-receiving opening formed in the connector.

17. The air duct opening cover assembly of claim 16, wherein the connector comprises an elastic, retainer clip.

18. The air duct opening cover assembly of claim 17, wherein the retainer clip comprises an angled arm, a lower clip member extending from the angled arm, a connecting member extending from the lower clip member and an upper clip member extending from the connecting member, wherein the lower and upper clip members define a gap therebetween configured to receive the structure.

19. An air duct opening cover assembly mountable on an air duct opening formed in a structure, the air duct opening cover assembly comprising:
a generally rigid, cover body, the cover body comprising at least one opening for the passing of air therethrough, the cover body positionable relative to an air duct opening formed in a structure such that the cover body extends over and across the air duct opening;
an air filter element, removably positionable against the cover body; and
a retainer system connectable to the cover body and extendable over and outward of the cover body to a periphery of the cover body, the retainer system comprising at least one fastener configured to connect to the structure at said periphery of the cover body; wherein
the air duct opening cover assembly is configured to adopt an assembled configuration in which the cover body is positioned over and across the air duct opening, with the air filter element arranged between the cover body and the air duct opening such that fluid communication is provided between the air duct opening and the at least one opening of the cover body through the air filter element, and the retainer system is connected to the cover body and extended over and outward of the cover body to said periphery of the cover body, with the at least one fastener connected to the structure, the retainer system maintaining the cover assembly and air filter element in place relative to the air duct opening.

20. An air duct opening cover assembly mountable on an air duct opening formed in a structure, the air duct opening cover assembly comprising:
a generally rigid, cover body, the cover body comprising at least one opening for the passing of air therethrough, the cover body positionable relative to an air duct opening formed in a structure such that the cover body extends over and across the air duct opening;
an air filter element, removably positionable against the cover body; and
a retainer system connectable to the cover body and extendable over and outward of the cover body to a periphery of the cover body, the retainer system comprising a plurality of fasteners configured to connect to the structure at said periphery of the cover body, wherein each fastener of the plurality of fasteners comprises an attachment member, the attachment member elongately formed and securable to the cover body at a respective first point of the cover body arranged in spaced-apart relationship with an outer edge of the cover body, said attachment member extendable over the cover body from said first point to the outer edge of the cover body, wherein a portion of said attachment member is extendable outward of the cover body to said periphery of the cover body and carries a connector configured to connect with the structure; wherein
the air duct opening cover assembly is configured to adopt an assembled configuration in which the cover body is positioned over and across the air duct opening, with the air filter element arranged between the cover body and the air duct opening such that fluid communication is provided between the air duct opening and the at least one opening of the cover body through the air filter element, and the attachment member of each fastener of the plurality of fasteners is connected to the cover body and extended over and outward of the cover body to said periphery of the cover body, with the connector of said each fastener is connected to the structure, with the attachment members of the fasteners stretched and biasing the cover assembly towards the air filter element thereby maintaining the air filter element in place relative to the air duct opening.
